(19) United States
(12) Patent Application Publication
(10) Pub. No.: US 2007/0173990 A1
(43) Pub. Date: Jul. 26, 2007

(54) Traction control for remotely controlled locomotive

(76) Inventors: Eugene A. Smith, Satellite Beach, FL (US); Glen Paul Peltonen, Palm Bay, FL (US); David Carroll Teeter, Satellite Beach, FL (US); Brian Lee Staton, Palm Bay, FL (US)

Correspondence Address: BEUSSE WOLTER SANKS MORA & MAIRE, P.A., 390 NORTH ORANGE AVENUE, SUITE 2500, ORLANDO, FL, 32801, US

(21) Appl. No.: 11/330,372

(22) Filed: Jan. 11, 2006

(51) Int. Cl. G05D 1/00

(52) U.S. Cl. 701/20

(57) ABSTRACT

A method for automatically controlling a traction condition of a locomotive (16) configurable for operation by remote control includes establishing a communication link (18) between an operator control unit (12) offboard the locomotive and a remote control unit (14) onboard the locomotive to assert control of the locomotive. The method also includes sensing a loss of traction condition of the locomotive while the locomotive is being remotely operated. The method further includes automatically controlling an operation of the locomotive to correct the loss of traction condition.

### FIELD OF THE INVENTION

This invention relates generally to the field of locomotives and more specifically to providing antislip and antiskid control for remotely controlled locomotives.

### BACKGROUND

It is known to remotely control locomotives in a rail yard using remote radio transmitting devices controlled by rail yard personnel. Such remote control systems may include an operator control unit (OCU) or control tower unit in remote communication with a locomotive control unit (LCU) on board the locomotive. The LCU interfaces with known locomotive systems, such as locomotive traction control systems, and pneumatic train braking systems, to direct the locomotive to move and stop according to commands transmitted for the OCU. For example, the LCU may provide commands to an automatic, or indirect, braking system for controlling braking of the locomotive (and any other locomotive or rail cars pneumatically attached to the locomotive) by modulating an air pressure in a brake pipe. The LCU may also provide commands to an independent, or direct, braking system for controlling braking of the locomotive, independently of the automatic system, by modulating an air pressure in a locomotive pipe. The LCU may also provide commands, such as throttle notch setting commands, to control a speed of the locomotive responsive to commands received from the OCU.

### BRIEF DESCRIPTION OF THE DRAWINGS

FIG. 1 is a schematic diagram of an example locomotive remote control system for automatically controlling operation of a remotely controlled locomotive during skid and slip conditions.

FIG. 2 is a schematic diagram showing more detailed braking control aspects of the remote control system of FIG. 1.

FIG. 3 is a schematic diagram showing more detailed traction control aspects of the remote control system of FIG. 1.

### DETAILED DESCRIPTION OF THE INVENTION

Conventional locomotive remote control systems function as isolated devices that allowed an operator, via a remote controller, such as an OCU in communication with an onboard controller, such as an LCU, to control some operations of a locomotive remotely. However, such systems may not provide advanced control functions that may be helpful in controlling locomotives remotely, such as antiskid and antislip control. The present invention expands the capabilities of a locomotive remote control system to improve the operation of a locomotive being remotely controlled. Productivity, safety, and efficiency of remote locomotive control operations may be enhanced by the addition of the control features described below.

FIG. 1 is a schematic diagram of an example locomotive remote control system 10 for automatically controlling operation of a remotely controlled locomotive 16 during skid and slip conditions. The remote control system 10 may include an OCU 12 in wireless communication via communication link 18 with a LCU 14 on-board the remotely controlled locomotive 16. The LCU 14 may provide control signals to a traction control system 20 for controlling application of traction applied to wheels 26 of the locomotive 16. The LCU 14 may also provide control signals to a braking control system 22 controlling application of brakes 28 of the locomotive 16 when the locomotive 16 is being operated under remote control. The LCU 14 may control operation of the traction control system 20 and/or a braking control system 22 to operate the locomotive 16 responsive to control commands input at the OCU 12. When not being controlled remotely, such as when the LCU 14 is configured in a standby mode, the locomotive 16 may be controlled according to control signals provided via operator controls 24 of the locomotive 16 receiving control inputs from an onboard operator. The LCU 14 may also be in communication with a traction condition sensor 30, such as one or more wheel speed sensors that may include an axle generator, sensing a traction condition of one or more wheels 26 of the locomotive 16. In an aspect of the invention, an input from the traction condition sensor 30, such as an axle generator, may be processed by the LCU 14 using known techniques to identify an anomalous traction condition of the locomotive 16, such as a wheel slip or a wheel skid condition. When an anomalous traction condition is sensed, the LCU 14 may automatically control one or both of the traction control system 20 and the braking control system 22 to correct the anomalous condition, for example, when the locomotive 16 is being controlled by the LCU 14 in a remote mode and/or when the LCU 14 is configured in a standby mode.

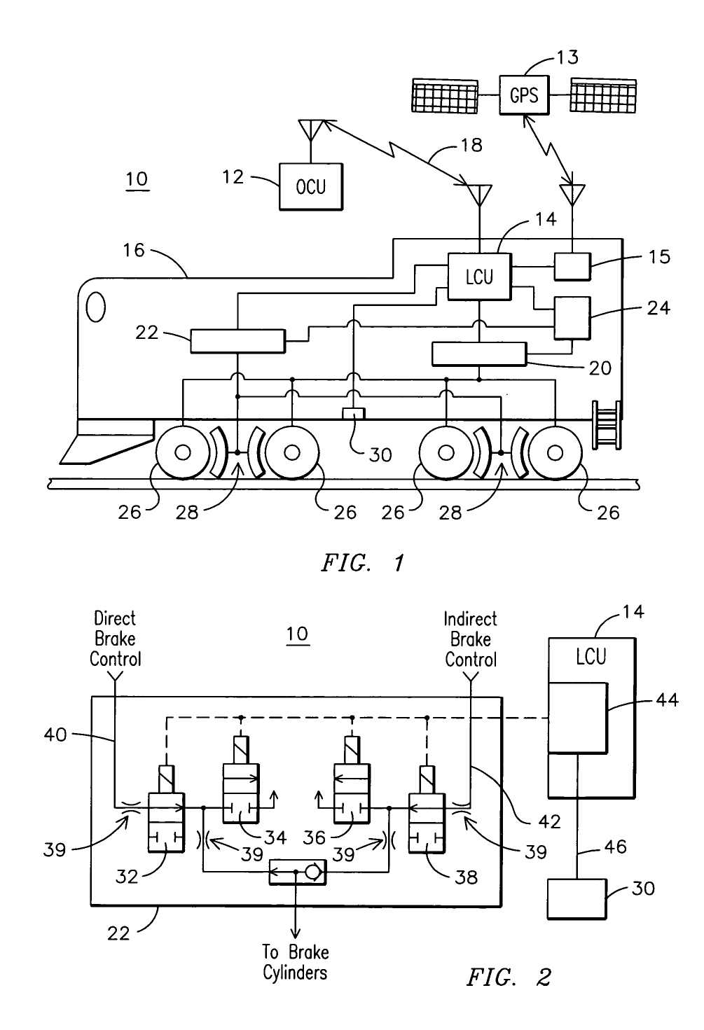

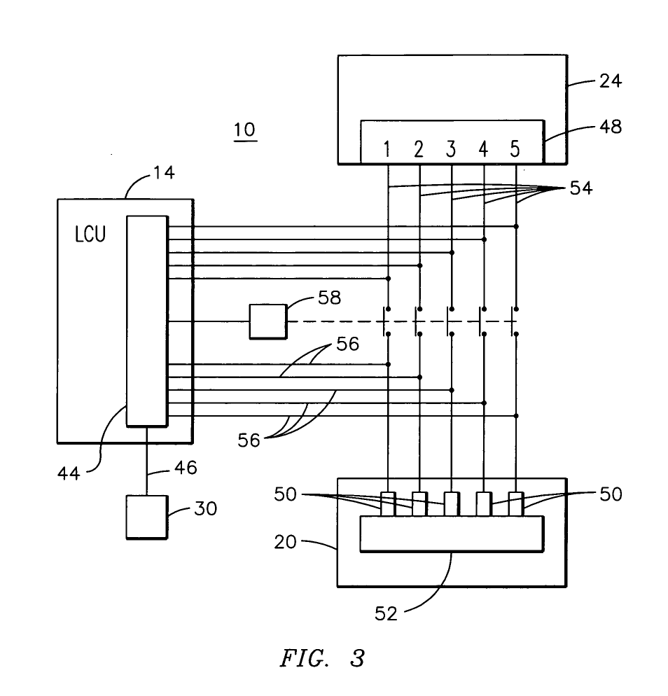

FIG. 2 is a schematic diagram showing more detailed braking control aspects of the remote control system 10 of FIG. 1. In the example embodiment shown in FIG. 2, antiskid valves 32, 34, 36, 38, such as solenoid controlled pneumatic valves, may be disposed in the direct 40 and indirect 42 brake lines to selectively control a braking application, for example, during a wheel skid condition. A pair of valves may be disposed in each brake line so that a blocking valve 32, 38 of the pair is operable to selectively block air flow to a brake cylinder (not shown) of the brakes 28 and a venting valve 34, 36 of the pair is operable to selectively vent air to the ambient atmosphere. According each pair of valves 32, 34, 36, 38 is operable to release a brake application, for example, to provide antiskid operation. In an unenergized state, the blocking valves 32, 38 may be positioned to allow passage of air to the brake cylinder and may be configured in an energized state, or activated, to prevent air an air flow from passing through the valves 32, 38. In an unenergized state, the venting valves 34, 36 may be positioned to prevent venting of air from the locomotive brake cylinders and respective lines 40, 42 and may be configured in an energized state, or activated, to vent air to the atmosphere to relieve air pressure in the locomotive brake cylinders. In a locomotive application, respective pairs of valves 32, 34, 36, 38 may be associated with each truck of the locomotive to control direct and indirect braking applied to each of the trucks.

The operation of the valves may be controlled by the LCU 14 responsive to a sensed traction condition, such as a wheel skid when the brakes are being applied. In an aspect of the invention, the LCU 14 may control operation of the valves 32, 34, 36, 38 in both a remote control mode when the LCU 14 directly controls operation of the locomotive 16 and in a standby mode wherein the locomotive 16 is being operated via the operator controls 24 by an onboard operator. The LCU 14 may include one or more processors 44 configured for determining a wheel skid condition and controlling an operation of the locomotive 16 to correct for a sensed wheel skid condition. The processor 44 may be configured to process a signal, for example, from the traction condition sensor 30, to determine if a wheel slip condition exists. For example, the processor 44 may be configured for monitoring respective speed samples received from a wheel sensor, such as an axle generator, over a period of time. A wheel skid condition may be declared by the processor 44 when a certain speed sample exhibits a decreased speed compared to recently acquired speed samples. For example, if two consecutive speed samples from an axle generator have a zero speed when a third consecutive speed sample taken just prior to the two speed samples has a speed greater than about 1 mile per hour (mph), then a wheel skid condition may be declared. In another aspect, a GPS speed signal derived, for example, from one or more GPS satellites 13 in communication with a GPS receiver 15 on board the locomotive 16, or other speed sensing mechanisms, may used to determine a wheel skid condition.

When a wheel skid condition is detected, the processor 44 may control the valves 32, 34, 36, 38 to release brake application for a certain time period, and then allow the brakes to be reapplied. For example, the processor 44 may energize, or activate, the valves 32, 34, 36, 38 to block air flow from the brake lines 40,42 and to release the brake cylinder pressure which releases the brake application to control a skid condition. After a certain time period, the processor 44 may then de-energized the valves 32, 34, 36, 38 to allow air to flow to the brake cylinders and block venting of air for reapplying the brakes. Brake release and reapplication may be cyclically commanded by the processor 44 until the skid condition is corrected. In an aspect of the invention, the processor 44 of the LCU 14 may be configured to activate the anti skid valves 32, 34, 36, 38 to release the brakes for a time period ranging from about 1 to 3 seconds, and more preferably, 2 seconds. After being released, the brakes may then be reapplied, for example by de-energizing the valves 32, 34, 36, 38 to allow air flow to the brake cylinders. Chokes 39 may be used in the anti skid valves to adjust and control the venting rate of the brake cylinder pressure and the subsequent charging rate of brake cylinder pressure. If skidding still occurs after reapplying the brakes, the antiskid valves 32, 34, 36, 38 may be reactivated to release the brakes for another time period. This cycle of brake application and release by the antiskid valves 32, 34, 36, 38 may continue as long as skidding occurs during commanded brake application.

In another embodiment the antiskid valves 32, 34, 36, 38 may be limited to a certain number of brake releasing activations in a certain time period. For example, the antiskid valves 32, 34, 36, 38 may be limited to two brake releasing activations during a 10 second time period. If a skidding condition is still detected after activating the antiskid valves 32, 34, 36, 38 a second time within 10 seconds from activating the valves 32, 34, 36, 38 a first time, then a third activation of the anti skid valves 32, 34, 36, 38 may be delayed until after the 10 second period expires.

In addition to activating the valves 32, 34, 36, 38 when a wheel skid condition is detected, the LCU 14 may activate application of a traction control agent, such as sand, to a track over which the locomotive is traveling to improve traction. The LCU 14 may also log the event to an event logger and may also provide a wheel skid alert to an operator, such as an operator operating the controls 24 or an operator of the OCU 12 if the locomotive is being operated remotely. In another aspect when the locomotive is being operated in a remote control mode, the processor 44 of the LCU 14 may be configured for declaring an emergency condition, such as when a certain number of skid conditions occur while performing periodic anti skid valve activations within a predetermined time period. For example, if third skid occurs after a second antiskid valve activation and within 10 seconds of a first skid, an emergency condition may be automatically declared. In another aspect, when the locomotive 16 is being operated in a remote control mode, the processor 44 of the LCU 14 may be configured for declaring an emergency condition, such as if the locomotive 16 continues to accelerate while performing periodic antiskid valve activations within a predetermined time period. For example, if five (5) consecutive samples of a GPS-derived speed signal indicate that the locomotive speed exceeds a locomotive speed at which the wheel skid condition was initially detected, an emergency condition may be automatically declared.

FIG. 3 is a schematic diagram showing more detailed traction control aspects of the remote control system of FIG. 1. In the example embodiment shown in FIG. 3, the operator control 24 may include a power controller wheel 48 having settings for controlling the traction control system 20, such as an array 52 of electro-pneumatic valves 50 controlling a power output of the engine. Each setting of the power control wheel 48 may provide a valve control sequence signal 54 to the electro-pneumatic valves 50. For example, each setting may be wired to control an electro-pneumatic valve 50 sequence that in turn controls a throttle notch setting of the engine responsive to a desired power output indicated by the power wheel 48. Each throttle notch setting responds to a predefined electro-pneumatic valve combination. As a notch setting is changed, a different valve combination is picked up which changes the engine speed, and resulting power output of the locomotive 16, accordingly.

The LCU 14 may include one or more processors 44 configured for determining a wheel slip condition and controlling an operation of the locomotive to correct for a sensed wheel slip condition. The processor 44 may be configured to process the signal 46 from the traction condition sensor 30 to determine if a wheel slip condition exists. In an aspect of the invention, the processor 44 may be configured to monitor respective speed samples, for example, received from a wheel sensor such as an axle generator, over a period of time. In another aspect, a GPS derived speed signal or other speed sensing mechanism may used to determine a wheel slip condition. A wheel slip condition may be declared by the processor 44 when a certain speed sample exhibits an increased speed compared to recently acquired speed samples. For example, a speed sample exhibiting an increase in speed in range of about of about 1.0 to about 2.0 miles per hour (mph) from an average speed calculated for about 2 to about 6 consecutive speed samples may be declared a wheel slip condition that may require correction.

In an LCU standby mode, in which the locomotive 16 is being operated by an onboard operator providing inputs at the operator controls, the LCU 14 may be configured for monitoring the power control settings, such as by monitoring the respective signals 54 provided to each of electro-pneumatic valves 50. The LCU 14 may be further be configured to selectively interrupt the signals 54 and to selectively provide alternate signals 56 for controlling the electro-pneumatic valves 50 during a wheel slip condition. The system 10 may include a switch, such as a relay 58, for example, operable by the LCU 14, for disconnecting the respective control connections between the power control wheel 48 and electro-pneumatic valves 50. The LCU 14 may further include respective connections 56 to the valves 50 to provide alternate control signals to the valves 50, for example, when the power control wheel 48 is disconnected from the valves 50 by the relay 58.

When a wheel slip condition is identified, the processor 44 of the LCU 14 may be configured to disconnect the power control wheel 48 from the control valves 50, such as by activating relay 58, and provide alternate control signals 56 to the control valves 50 to correct for the identified slip condition, such as by lowering a power output of the engine and then gradually ramping power back up to a notch setting position responsive to a present setting of the power control wheel 48. When a wheel slip condition is detected in standby mode, the processor 44 may be configured for dropping a throttle notch setting to predetermined setting for a certain time period depending on a monitored power wheel setting at the time of wheel slip. For example, a throttle setting of the engine may be commanded by the LCU 14 to drop to a notch 2 setting for a certain duration according to a power wheel 48 setting as shown in Table 1:

TABLE 1
Example Notch 2 Setting Durations for Power Wheel Position

| Power Wheel Setting | Notch 2 Duration (seconds) |
|---|---|
| >12 | 6 |
| 9-12 | 5 |
| 5-8 | 4 |
| <5 | 3 |

After holding at notch 2, the notch setting may be gradually stepped up to return the notch setting to a notch setting position responsive to a present setting of the power control wheel 48 according to the schedule shown in TABLE 2:

TABLE 2
Example Engine Throttle Notch Hold Durations When Stepping Back to
Original Notch Setting

| Engine Throttle Notch | Hold Durations (seconds) |
|---|---|
| N3 | 2.0 |
| N4 | 2.0 |
| N5 | 1.5 |
| N6 | 1.5 |
| N7-N15 | 1.0 |

In addition to reducing power when wheel slip is detected, the LCU 14 may activate a track sanding operation to improve traction and may also provide a wheel slip alert to an operator. After the wheel slip condition is remedied, the LCU 14 may return control to the power control wheel 48 by reconnecting the power condition wheel 48 to the electro-pneumatic valves 50, such as by deactivating relay 58.

In an LCU 14 remote mode wherein the locomotive is being operated remotely via the OCU 12, the LCU 14 may be configured for directly controlling an engine throttle notch position for controlling a speed of the locomotive 16 responsive to commands received from the OCU 12. When a wheel slip condition is identified, the processor 44 may be configured for dropping a throttle notch setting to a predetermined setting for a certain time period depending on a notch setting commanded by the LCU 14 at the time of wheel slip. For example, a throttle setting of the engine may be commanded by the LCU 14 to drop to a notch 2 setting for a certain duration, for example, according to the schedule as shown in Table 1. In addition to reducing power when wheel slip is detected, the LCU 14 may activate a track sanding operation to improve traction. The LCU 14 may also log the event to an event logger and may also provide a wheel slip alert to operator of the OCU 12. After remaining at notch setting 2 for a predetermined duration, the throttle setting may then be gradually stepped back up to reach an OCU 12 commanded speed, for example, according to the schedule as shown in Table 2.

Based on the foregoing description, the methods described may be implemented using computer programming or engineering techniques including computer software, firmware, hardware or any combination or subset thereof, wherein the technical effect is to provide antislip and antiskid control for a remotely controlled locomotive. Any such resulting program, having computer-readable code means, may be embodied or provided within one or more computer-readable media, thereby making a computer program product, i.e., an article of manufacture, according to the invention. For example, computer readable media may contain program instructions for a computer program code for processing received imaging data indicative of images acquired in a vicinity of a locomotive. The computer readable media may also include a computer program code for processing received location data indicative of a geographic location of the locomotive when the images are being acquired. In addition, the computer readable media may include a computer program code for accessing a railroad landmark database comprising a plurality of railroad landmarks associated with respective geographic locations constituting landmark tags to correlate the landmark tags with the imaging data and the location data to generate landmark correlated image data.

The computer readable media may be, for example, a fixed (hard) drive, diskette, optical disk, magnetic tape, semiconductor memory such as read-only memory (ROM), etc., or any transmitting/receiving medium such as the Internet or other communication network or link. The article of manufacture containing the computer code may be made and/or used by executing the code directly from one medium, by copying the code from one medium to another medium, or by transmitting the code over a network.

One skilled in the art of computer science will be able to combine the software created as described with appropriate general purpose or special purpose computer hardware, such as a microprocessor, to create a computer system or computer sub-system embodying the method of the invention. An apparatus for making, using or selling the invention may be one or more processing systems including, but not limited to, a central processing unit (CPU), memory, storage devices, communication links and devices, servers, I/O devices, or any sub-components of one or more processing systems, including software, firmware, hardware or any combination or subset thereof, which embody the invention.

While certain embodiments of the present invention have been shown and described herein, it will be obvious that such embodiments are provided by way of example only. Numerous variations, changes and substitutions may be made without departing from the invention herein. Accordingly, it is intended that the invention be limited only by the spirit and scope of the appended claims.

1. A method for automatically controlling a traction condition of a locomotive configurable for operation by remote control comprising:
establishing a communication link between an operator control unit offboard the locomotive and a remote control unit onboard the locomotive to assert control of the locomotive;
sensing a loss of traction condition of the locomotive while the locomotive is being remotely operated;
automatically controlling an operation of the locomotive to correct the loss of traction condition.

2. The method of claim 1, wherein the loss of traction condition comprises a wheel skid during application of locomotive brakes.

3. The method of claim 2, further comprising identifying a wheel skid when a wheel speed sample acquired by the locomotive exhibits a decreased speed compared to one or more recently acquired wheel speed samples.

4. The method of claim 2, further comprising intermittently releasing and then reapplying the locomotive brakes until the loss of traction condition is corrected.

5. The method of claim 4, wherein a number of intermittent releases is limited during a predetermined time period.

6. The method of claim 1, wherein the loss of traction condition comprises a wheel slip during a traction application by the locomotive.

7. The method of claim 6, further comprising identifying a wheel slip when a wheel speed sample acquired by the locomotive exhibits a increased speed compared to one or more recently acquired wheel speed samples.

8. The method of claim 6, further comprising reducing a traction application applied by the locomotive until the loss of traction condition is corrected.

9. The method of claim 1, further comprising applying a traction control agent to a track over which the locomotive is traveling when the loss of traction condition is sensed.

10. The method of claim 1, further comprising declaring an emergency condition when the loss of traction condition cannot be corrected within a predetermined time period.

11. A system for automatically controlling a traction condition of a locomotive configurable for operation by remote control comprising:
an operator control unit off board a locomotive to provide control signals for remotely operating the locomotive;
a remote control unit onboard the locomotive to control an operation of the locomotive responsive to the control signals;
a sensor to sense a loss of traction condition of the locomotive while the locomotive is being remotely operated;
a processor in communication with the remote control unit; and
programmed logic operable with the processor to automatically control an operation of the locomotive to correct the loss of traction condition.

12. The system of claim 11, further comprising a first brake line valve to selectively block a flow of air to a brake of the locomotive responsive to a sensed loss of traction condition when the brake of the locomotive is being applied.

13. The system of claim 11, further comprising a second brake line valve to selectively release air from a brake cylinder of the locomotive responsive to a sensed loss of traction condition when the brake of the locomotive is being applied.

14. The system of claim 11, wherein the speed sensor comprises an axle generator.

15. The system of claim 11, wherein the speed sensor comprises a GPS receiver in communication with a GPS satellite.

16. The system of claim 11, further comprising a switch to selectively interrupt transmission of a traction control signal from an onboard operator control panel of the locomotive and allow the remote control unit to provide and alternate traction control signal responsive to a sensed loss of traction condition when traction is being applied by the locomotive.

17. A method for automatically controlling a traction condition of a locomotive configurable for operation by remote control comprising:
monitoring a traction control signal generated by an onboard operator control of a locomotive by a remote control unit onboard the locomotive and configured for standby operation;
sensing a loss of traction condition of the when the locomotive is being operated via the onboard operator control;
interrupting the traction control signal; and
providing an alternate traction control signal from the remote control system to correct the loss of traction condition of the locomotive.

18. The method of claim 17, further comprising returning traction control to the onboard operator control after the loss of traction condition is corrected.

19. The method of claim 17, wherein the alternate traction control signal commands a reduction of a traction application applied by the locomotive until the loss of traction condition is corrected.

20. Computer readable media containing program instructions for automatically controlling a traction condition of a locomotive configurable for operation by remote control, the computer readable media comprising:
a computer program code for establishing a communication link between an operator control unit off board the locomotive and a remote control unit onboard the locomotive to assert control of the locomotive;
a computer program code associated with a sensor for sensing a loss of traction condition of the locomotive while the locomotive is being remotely operated; and
a computer program code for automatically controlling an operation of the locomotive to correct the loss of traction condition.
